(19) United States
(12) Patent Application Publication
(10) Pub. No.: US 2007/0172596 A1
(43) Pub. Date: Jul. 26, 2007

(54) Epoxy sealer/healer for sealing and strengthening cracked concrete

(76) Inventors: Stuart J. Hartman, Livingston, NJ (US); David C. Elmendorf, Ringwood, NJ (US); Steven A. Rosenberg, Succasunna, NJ (US)

Correspondence Address: BINGHAM MCCUTCHEN LLP, Three Embarcadero Center, San Francisco, CA, 94111-4067, US

(21) Appl. No.: 11/224,073

(22) Filed: Sep. 13, 2005

(51) Int. Cl. B05D 3/02

(52) U.S. Cl. 427/386

(57) ABSTRACT

An epoxy sealer/healer formulation for sealing and strengthening cracked concrete. This sealer/healer has reduced fuming and exhibits a lower exotherm.

### FIELD OF THE INVENTION

The present invention relates to an epoxy sealer/healer for sealing and strengthening cracked concrete.

### DESCRIPTION OF THE RELATED ART

Concrete is used to make many structures, including bridges, roadways, tunnels, runways, parking ramps and decks, parapet walls, precast beams, columns, curbing, retaining walls and pavers. These structures commonly develop cracks upon exposure to the environment and to man-made activities. Thus, there is a widespread need for a composition for sealing and repairing cracked concrete structures.

Numerous compositions for sealing cracked concrete are known. One example is methacrylate-based formulations. These compositions suffer, however, from the disadvantages of being brittle, not useable under wet conditions, and generally slow curing. Another example is poly-siloxane-based resin formulations. These are not useable to seal visible cracks but, rather, are used as penetrants.

Epoxy-based compositions for sealing cracks in concrete are also known. A commercially available product called Denepox 40 has been marketed by DeNeef America Inc. Denepox 40 was said to be a low viscosity, two-component epoxy resin system which can be applied to concrete cracks by pressure injection or by gravity feeding. Denepox 40 is a 100% solids resin said to be insensitive to the presence of water and useful for application to damp concrete surfaces. Denepox 40 was advertised as having a pot life of 80 minutes at 77° F., and a mixing viscosity of 40 centipoise at that temperature.

Versafill 60A/60B was a product made by Henkel Corporation and was a two-component epoxy system designed to penetrate and bond cracks in concrete structures. The material could either be injected or applied through gravity feed. Versafill 60A/60B was said to penetrate deeply into a crack (down to 4 thousandths of an inch in width), have little odor, and contain no solvents. The mixed two-component epoxy system was advertised as having a viscosity of 300-500 centipoise and a gel time of about 60 minutes.

Dural 335 was marketed by Tamms Industries and was characterized as a two-component, 100% solids, low viscosity epoxy resin for sealing concrete cracks and surfaces. Dural 335 was said to flow readily for deep penetration into cracks; the mixed formulation purportedly having a viscosity of 83 centipoise at 75° F., and a pot life of 40-50 min. Although the cured formulation was said to be moisture insensitive, surfaces and cracks must be completely dry before application of Dural 335 to obtain maximum penetration, and to obtain adequate bond strength.

While epoxy-based formulations for sealing cracked concrete are known, they suffer from several disadvantages. Epoxy-based formulations usually have had a high viscosity which, therefore, leads to poor crack penetration. Epoxy-based formulations also tend to have long tack-free times and some cannot bond to concrete and/or cure in the presence of moisture.

U.S. Pat. No. 6,068,885 to Hartman et al and assigned to the assignee of this application, describes epoxy sealer/healers for sealing and bonding cracked concrete, by both gravity feed and injection. These sealer/ healers have a low viscosity and substantially and deeply penetrate cracked concrete. Also, the sealer/healers have structural repair properties when applied to cracked concrete, and bond to cracked concrete under moist conditions. In addition, the epoxy sealer/healers have improved tack-free times, and have useable working lives for most practical applications.

Sika has marketed a particular low viscosity sealer/healer according to the 885 patent under the trade name “Sikadur 55 SLV”. This product was found to have excellent sealer/healer properties. The “Sikadur” product is a two-part formulation. The first part, designated Part A, comprises about 48 weight % of a bisphenol A-epichlorohydrin resin sold under the trade name Araldite 6005 marketed by Huntsman Advanced Materials (which contains about 4% para-tertiary butylphenyl glycidyl ether), about 41 weight % neopentyl glycol diglycidyl ether (a diepoxide reactive diluent), about 7.5 weight % of neodecanoic glycidyl ether (a monoepoxide reactive diluent), and about 3.5 weight % of furfuryl alcohol (a hydroxylated aromatic diluent). The second part, designated Part B, comprises about 69.5 weight % of the amine curing agent isophorone diamine, about 10.5 weight % of an aliphatic amine sold under the trade name Ancamine AD (marketed by Air Products and Chemical Co.) which is the reaction product of phenol, a 1:1 adduct of diethylene triamine and ethylene oxide, and diethylene triamine, about 12 weight % of 2,4,6-tri(dimethylaminomethyl)phenol (a tertiary amine), about 4.75 weight % benzyl alcohol, and 3.25 weight % salicylic acid.

The Sikadur sealer/healer has been an excellent product for sealing and bonding cracked concrete. More particularly, the product has a low viscosity which allows for substantial and deep penetration into cracked concrete, structural repair properties for effectively returning the concrete to the same strength condition as uncracked concrete, and excellent handling properties giving it a usable working life for most practical applications. Furthermore, the Sikadur healer/sealer proved to be advantageous because it can effectively bond in damp and wet conditions.

Unfortunately, the Sikadur product has also been found to have drawbacks. In particular, it was discovered that the product has a very high exotherm, and exhibits excessive fuming and a high potential for boil-over. Also, the product, as formulated with Ancamine AD to provide a dialkylene triamine-alkylene oxide adduct, contained a substance, phenol, in quantities which are banned in several countries, thereby limiting its world-wide distribution. The need existed, therefore, to address these undesirable characteristics.

### OBJECTS AND SUMMARY OF THE INVENTION

It is a general object of the present invention to provide an improved epoxy composition for effectively sealing and bonding cracked concrete, by both gravity feed and injection.

A more specific object of the present invention is to provide a low viscosity epoxy sealer/healer which substantially and deeply penetrates cracked concrete and addresses those drawbacks of the prior art. Preferably, the present invention will provide an epoxy sealer/healer with structural repair properties when applied to cracked concrete, and which will bond to cracked concrete under moist conditions. In this regard, it is an object of the invention to provide such an epoxy sealer/healer which also exhibits a lower exotherm, lower fuming, lower potential for boil-over, and contains no materials which would limit its world-wide distribution.

It is still a further object of the present invention to provide such epoxy sealer/healers for use on cracked concrete having suitable tack-free times. Preferably, the epoxy sealer/healer for cracked concrete will have a useable working life for most practical applications.

Accordingly, in one aspect the invention provides an epoxy sealer/healer for sealing and strengthening cracked concrete comprising an epoxy resin and an amine, but does not require a dialkylene triamine-alkylene oxide adduct, said formulation exhibiting a peak exotherm of no more than 480° F. (250° C.), preferably no more than 455° F. (235° C.), when measured according to ASTM D 2471, except that one quart volume is tested in a ½-gallon paint can (approximately 5.3 in. (13.5 cm.) in diameter by 5.7 in. (14.5 cm.) deep. The invention also provides a modulus and/or compressive strength at least that of uncracked concrete while being effective for penetrating a concrete crack at a rate of at least 10 mm/min for a crack 0.5 mm wide when applied by gravity feed. Preferably, a sealer/healer according to the invention can fully penetrate cracks as small as 0.1 mm in width, and more preferably, as small as 0.05 mm in width, or even smaller

In another aspect, the invention provides an epoxy sealer/healer for sealing and strengthening cracked concrete comprising a wet surface-bonding, concrete crack self-penetrating formulation of an epoxy resin and amine, where the formulation has a tack-free time of 12 hours or less at 73° F.

In yet another aspect, the invention provides a self-penetrating epoxy sealer/healer for sealing and strengthening cracked, moist concrete comprising an epoxy resin and amine, but does not require an dialkylene triamine-alkylene oxide adduct, where the formulation has a tack-free time of 6 hours or less at 73° F. and a viscosity of about 140 centipoise (cps) or less at 73° F., preferably about 125 cps or less, and even more preferably about 110 cps or less.

In still another aspect, the invention provides a method of sealing and restoring the strength of cracked concrete, comprising applying to a cracked concrete surface an epoxy sealer/healer comprising an epoxy resin and an amine, but does not require a dialkylene triamine-alkylene oxide adduct, said formulation exhibiting a peak exotherm of no more than 480° F. (250° C.), preferably no more than 455° F. (235° C.), when measured according to ASTM D 2471, except that one quart volume is tested in a ½-gallon paint can (approximately 5.3 in. (13.5 cm.) in diameter by 5.7 in. (14.5 cm.) deep, and providing a modulus and/or compressive strength at least that of uncracked concrete while being effective for penetrating a concrete crack at a rate of at least 10 mm/min for a crack 0.5 mm wide when applied by gravity feed.

### DETAILED DESCRIPTION OF THE INVENTION

As noted above, the present invention relates to an epoxy sealer/healer for sealing and strengthening cracked concrete. The epoxy sealer/healer can be characterized as a mixture of two parts, designated as Part A and Part B. Part A comprises an epoxy resin. Part B comprises an amine hardener. Usually, Parts A and B each will further comprise one or more diluents. Typically, Part B will contain an accelerator. Part A may also contain an accelerator.

By sealer/healer as used herein, it is intended that such a composition will fill and seal cracks in concrete, thereby preventing water or other foreign matter from entering the concrete. In addition, the sealer/healer will bond to the inner surfaces of the crack thereby healing the concrete, i.e., increasing the modulus and/or compressive strength of the cracked concrete. An advantageous aspect of the invention is that the cured epoxy sealer/healer can increase the modulus and/or compressive strength of cracked concrete to at least that of uncracked concrete.

The epoxy resin contained in Part A is preferably a bisphenol A-epichlorohydrin resin, such as Araldite 6010 (marketed by Huntsman Advanced Materials). However, other epoxy resins may also be used, including bisphenol F-epichlorohydrin resin, such as Epalloy 8230 (marketed by CVC Specialty Chemicals, Inc.), brominated epoxy resins and multifunctional resins such as a phenolic-epichlorohydrin resin. Part A will typically contain from about 40 to about 75 percent by weight of epoxy resin, and preferably contains from about 50 to 65 percent by weight.

In a particularly preferred embodiment, a combination of bisphenol A-epichlorohydrin resin and bisphenol F-epichlorohydrin resin is used. In this embodiment about 30 to about 50 weight percent of the bisphenol A resin, preferably about 35 to about 45 weight percent, and most preferably about 40 weight percent, is used, and about 15 to about 25 weight percent, preferably about 17 to about 23 weight percent, and most preferably about 21 weight percent bisphenol F-epichlorohydrin resin is used.

While not wishing to be bound by theory, it is believed that with this bisphenol A and bisphenol F mixture, the bisphenol A component functions as the main resin for cure, while the bisphenol F component is believed to maintain the desired functionality, i.e., it minimizes the chain shortening effect on properties from the monofunctional diluents which may be present. The bisphenol F resin is also believed to reduce any tendency of Part A to crystallize.

Part A also contains a diluent in order to reduce viscosity. Part A will typically contain diluents in an amount of ranging from about 30 to about 50 percent by weight. The diluent may be one component or, more often, is a mixture of components. Reactive diluents become part of the crosslinked polymer, and are preferred over non-reactive types because reactive diluents are believed to affect the properties of epoxy systems the least. Reactive diluents can contain various types of reactive functionalities. Preferred reactive diluents include difunctional epoxides and monofunctional epoxides.

The inventors have discovered that excessive amounts of difunctional epoxide diluents were the cause of the substantial fuming and high exotherms observed with the assignee's predecessor Sikadur product. However, the presence of the difunctional epoxide components functioned very well to lower viscosity without adversely affecting the desired strength characteristics. Thus, it is an important aspect of the present invention to provide a formulation that minimizes fuming and lowers the exotherm while still utilizing components that provide a satisfactory viscosity for achieving the necessary crack penetration. Also, the composition cannot be so formulated as to adversely affect the final strength properties.

Accordingly, one preferred embodiment uses both difunctional and monofunctional epoxide diluents. The amounts and combination of these diluents are selected to provide the necessary viscosity characteristics without adversely affecting strength characteristics and without causing an unacceptably high exotherm or excessive fuming. Preferably the peak exotherm of the final product should be no more than 480° F. (250° C.), preferably no more than 455° F. (235° C.), when measured according to ASTM D 2471, except that one quart volume is tested in a ½-gallon paint can (approximately 5.3 in. (13.5 cm.) in diameter by 5.7 in. (14.5 cm.) deep. A composition according to the invention also should not fume to produce a smoke density of more than 100 Ds, preferably should not fume more than about 75 Ds, and most preferably should fume less than about 50 Ds, when measured by ASTM E 662 modified such ½-gallon volumes are run in a 1-gallon metal cans and no external heat is applied to the sample.

The smoke density test of ASTM E662 provides quantitative measurements of smoke by providing a light attenuation versus time plot for the specimen tested. The maximum quantity of smoke accumulation as well as the smoke production rate is obtained. The results of the smoke measurements are reported in terms of specific optical density.

In this preferred embodiment, when utilizing a mixture of reactive epoxide diluents the amount of difunctional reactive epoxide diluent should not exceed about 18 weight percent. Preferably, the difunctional reactive diluent is present in an amount of about 15 to 16 percent by weight. On the other hand, the difunctional reactive diluent should be present in an amount of at least about 10 weight percent by weight.

Along with the difunctional epoxide, Part A should contain a monofunctional diluent which will assist in lowering viscosity but will not cause excessive fuming or increase the exotherm to unacceptable levels. However, monofunctional diluents exhibit a chain stopping effect that can adversely affect final strength properties. Therefore, the amount of monofunctional diluent should be limited. Preferably, Part A contains at least about 15 weight percent reactive monofunctional epoxide diluent, but no more than about 25 weight percent. More preferably, Part A contains about 20 to about 25 weight percent monofunctional reactive diluent.

Possible diluent components according to the invention include, for example, diepoxides such as neopentyl glycol diglycidyl ether, 1,4-butanediol diglycidyl ether, resorcinol diglycidyl ether and vinyl cyclohexene dioxide, of which neopentyl glycol diglycidyl ether is preferred. Monoepoxide diluents include, for example, neodecanoic glycidyl ether, alkyl glycidyl ether such as 2-ethylhexyl glycidyl ether, butyl glycidyl ether, cresyl glycidyl ether, glycidyl methacrylate, phenyl glycidyl ether, and olefin oxides, of which neodecanoic glycidyl ether is preferred.

In a particularly preferred embodiment, Part A contains as a diluent a combination of from about 10 to about 18 weight percent, preferably about 15 to aboutl6 weight percent, neopentyl glycol diglycidyl ether (difunctional), from about 0 to about 20 weight percent, preferably about 5 weight percent, neodecanoic glycidyl ether (monofunctional), and from about 10 to about 20 weight percent, preferably about 19 weight percent, 2-ethylhexyl glycidyl ether (monofunctional).

Another class of diluents which may be used according to the invention contains compounds which act not only to reduce viscosity, but which also act as accelerators for the curing reaction. Examples of such diluents include aromatic compounds which possess a hydroxyl functionality, such as nonyl phenol. Especially useful are aromatics with hydroxylated alkyl side chains, such as benzyl alcohol and furfuryl alcohol. If included, the hydroxylated aromatic diluent can be added in a amount of from about 2 weight percent to about 10 weight percent of Part A.

Part B of the two-component epoxy sealer/healer contains one or more amine curing agents. Examples of amine curing agents include aliphatic primary, secondary and tertiary amines, aromatic amines, cycloaliphatic amines, heterocyclic amines, amido amines and polyether amines. Preferred amines include isophorone diamine and aminoethyl piperazine. A combination of isophorone diamine and aminoethyl piperazine is most preferred.

The curing agent can include from about 5 to about 15, preferably from about 8 to about 12 percent by weight, of an amine which acts as an accelerant, e.g., a compound which contains both tertiary amine and hydroxyl functionalities. A preferred amine-accelerant is 2,4,6,-tri(dimethylaminomethyl)phenol.

The total amount of curing agent(s) may range from about 50 to about 70 weight percent, preferably about 60 to about 65 weight percent.

Part B of the epoxy sealer/healer may also include one or more accelerants in addition to, or in place of, the amine/accelerant. Preferably Part B contains about 15 to about 25% by weight non-amine accelerant(s), more preferably about 18 to about 22% by weight. Suitable as such accelerants are any which contain a hydroxyl functionality. Preferred accelerants are styrenated phenol such as Novares LS-500 (marketed by Ruitgers Chemicals AG) and salicylic acid. Phenol and nonyl phenol could be used but should be avoided because its use is banned in several countries. Preferred is a combination of styrenated phenol and salicyclic acid.

One advantage of the present invention is that Part B does not require, and may be free of, an adduct of a dialkylene triamine such as diethylene triamine, and an alkylene oxide such as ethylene oxide or propylene oxide.

Part B may also contain from about 15 to about 25, preferably about 15 to about 20 percent by weight of diluent(s). Preferred is a hydroxylated aromatic diluent such as benzyl alcohol, which can also be used as an accelerator.

Part B contains amine curing agents which are in approximately stoichiometric amounts with respect to the amount of epoxy resin in Part A with which Part B will be mixed. Part B can generally contain about 53% by weight of amines, about 10% by weight of amine accelerants, about 20% by weight accelerants, and about 17% by weight of diluent, preferably a hydroxylated aromatic diluent.

For use, Parts A and B of a two-part epoxy sealer/healer according to the invention are mixed such that there is an approximately stoichiometric ratio of epoxy resin to amine curing agent. Accordingly, the weight ratio for mixing of Part A to Part B can range from 10:1 to 1:1. In a preferred embodiment, Parts A and B are mixed at a weight ratio of 2:1 to 3.5:1. In the most preferred embodiment Parts A and B can be mixed in a whole volume ratio, i.e., 2:1. This provides a practical advantage in that less than whole packaged units can be easily prepared when only small amounts are needed. Mixing less than whole packaged units decreases the potential for exotherm problems.

An advantage of the epoxy sealer/healer according to the invention is that it can be applied by gravity feed. For example, the epoxy sealer can be poured directly onto the cracked concrete surface and, if needed, spread using a roller, broom, squeegee or other applicable device. Enough epoxy sealer/healer should be applied such that all cracks are filled. Large cracks may first be filled with sand or other appropriate filler prior to application of the epoxy sealer/healer.

Though not usually necessary, the epoxy sealer/healer can also be applied by pressure injection. The ability to inject the epoxy sealer/healer with a low pressure is a significant advantage since not all cracks can be filled using gravity. Furthermore, in a complex structure such as a tunnel or bridge-head, the cracks are branching so that use of low pressure injection will have a significant effect. Low pressure injection is preferred because it is easy to install and maintain at low cost. Low pressure injection is generally performed at a pressure of up to about 20 psi, preferably at about 10 to about 12 psi. The low viscosity of the epoxy sealer/healer of the invention combined with the toughness of the cured material will allow its use as a repair material in cracked concrete dams and other structures that need structural crack bonding. The epoxy sealer/healer can be injected in those applications.

Controlling viscosity assists in providing a gravity feedable epoxy sealer/healer. For example, the viscosity at 73° F. should be no greater than 140 cps so that the epoxy sealer/healer can penetrate and fill all cracks in the concrete surface. Diluents can be used which compensate for the viscosity of the particular epoxy resin and amine hardener present in Parts A and B, respectively. Furthermore, diluents are used which do not result in a significant deterioration of properties of the cured resin, such as strength and modulus. An advantage of using diluents as described herein is that the addition of surface tension reducers is not necessary to provide the requisite crack penetration.

Generally, the epoxy sealer/healer of the invention will penetrate a concrete crack at a rate of at least 10 mm/min for a crack 0.5 mm wide when applied by gravity feed. Preferably, the gravity feed penetration rate is at least 10 mm/min for a crack 0.1 mm wide, more preferably, at least 75 mm/min for a crack 0.1 mm wide.

Another advantageous feature of epoxy sealer/healer formulations according to the invention is their tack-free time. Tack-free time is the time it takes the mixture of Parts A and B to become dry to the touch. In general, the tack-free time at 73° F. (23° C.) will be no more than 12 hours, usually no more than 8 hours. The invention can even provide a tack-free time of no more than 6 hours.

The tack-free time is a function not only of the epoxy resin and amine in the sealer/healer, but depends on the amounts and types of diluents added, and accelerators as well. By adding more than one type of accelerator, catalysis occurs by more than one mechanism. This provides the quickest tack-free time. For example, the amine addition reaction is greatly accelerated by the presence of a hydroxyl group or other hydrogen donor, such as phenol, salicylic acid or benzyl alcohol. The hydroxyl group is believed to hydrogen bond with the epoxy oxygen and thereby aid in the formation of a three-membered hydroxyl-epoxy-amine transition state, which subsequently yields the amine-epoxy addition product and hydroxyl group. An additional mechanism by which catalysis occurs is via the use of tertiary amines, such as 2,4,6-tri(dimethylaminomethyl)phenol, which act as Lewis bases. The tertiary amines are thought to provide catalysis by temporarily attaching to one of the carbon atoms of the epoxy group of the resin, thereby facilitating the interaction of the epoxy oxygen with a hydroxyl compound, with subsequent production of an alkoxide ion. The alkoxide ion can then react directly with an available epoxy group to generate a new alkoxide ion.

Another advantageous feature of epoxy sealer/healer formulations according to the invention is the useable working life of those formulations. The working life of an epoxy sealer/healer composition according to the invention is the time after admixture of Parts A and B in which the epoxy sealer/healer can be applied to concrete before gelling of the mixture occurs. An epoxy sealer/healer according to the invention can have a working life of at least 15 minutes at 73° F. (23° C.), preferably as long as 20 minutes or longer.

The epoxy sealer/healer can heal concrete cracks to a strength as great as that of uncracked concrete. The cured sealer/healer can achieve a compressive modulus of at least 250,000 psi and a compressive strength of at least 11,000 psi.

The addition of fillers to the epoxy sealer/healer is not required. Generally, the addition of fillers should be avoided since they will result in an increase in the viscosity of the epoxy sealer/healer.

The following example provides an illustration of the invention. The example, however, should not be construed as limiting the invention in any way.

### EXAMPLE 1

A two-part epoxy healer/sealer according to the invention was prepared. Part A and Part B were formulated as follows:

PART A

| Component | % By Weight |
|---|---|
| Araldite 6010* | 40 |
| Neopentyl Glycol Diglycidylether | 15 |
| Neodecanoic Glycidyl Ether | 5 |
| Epalloy 8230** | 21 |
| 2-Ethylhexyl Glycidylether | 19 |

*Araldite 6010 is a standard bisphenol A resin marketed by Huntsman Advanced Materials.
**Epalloy 8230 is a bisphenol F resin marketed by CVC Specialty Chemicals, Inc.

PART B

| Component | % By Weight |
|---|---|
| Isophorone Diamine | 42 |
| Aminoethyl Piperazine | 11 |
| 2,4,6,-Tri(dimethylaminomethyl) phenol | 10 |
| Novares LS 500* | 17 |
| Benzyl Alcohol | 17 |
| Salicylic Acid | 3 |

*Novares LS 500 is a styrenated phenol marketed by Rutgers Chemicals AG.
Part A and Part B are mixed in a ratio of 2:1 by volume.

### EXAMPLE 2

The product of Example 1 was tested for a variety of properties. These characteristics were then compared with those of Sikadur 55 SLV. The compared characteristics are set forth below:

| | TEST | |
|---|---|---|
| | | SIKADUR |
| | EXAMPLE 1 | 55 SLV |
| | FORMULATION | @73° F. |
| | @73° F. (23° C.) | (23° C.) |
| Exotherm, ° F. (° C.)* | 450 (232) | 536 (280) |
| Fuming, visual observation* | Intermittent, | black |
| | small puffs of | billowing |
| | white smoke | smoke |
| Compressive Strength, psi | | |
| (ASTM D-695) | | |
| 1 day | 1,100 | 250 |
| 3 day | 8,300 | 11,600 |
| 7 day | 10,900 | 13,700 |
| 14 day | 11,800 | 14,000 |
| 28 day | 12,000 | 14,000 |
| Compressive Modulus, psi | | |
| 7 day | 300,000 | 370,000 |
| Tensile Strength, 7 day, psi | 7,100 | 7,500 |
| (ASTM D-638) | | |
| Elongation at Break, % | 11.0 | 2.5 |
| Flexural Properties, 7 day | | |
| (ASTM D-790) | | |
| Flexural Strength, psi | 8,500 | 9,500 |
| Tangent Modulus of elasticity, psi | 3.2 × 10⁵ | 4.8 × 10⁵ |
| Tack Free Time, hrs | 5.5-6 | 6 |
| Bond Strength (ASTM C-882) | | |
| Hardened Concrete to Hardened | | |
| Concrete, psi | | |
| 2 day (moist cure) | 2,500 | 1,400 |
| 14 day (moist cure) | 2,500 | 2,700 |
| Hardened Concrete to Steel, psi | | |
| 2 day (moist cure) | 1,500 | 1,900 |
| 14 day (moist cure) | 1,600 | 2,100 |
| Shear Strength, psi | 5,800 | 7,600 |
| (ASTM D-732) | | |
| Heat Deflection Temp., ° F. | 110 | 120 |
| (ASTM D-648) | | |
| Water Absorption, 7 day, % | 0.6 | 0.6 |
| (ASTM-570) | | |
| Viscosity (mixed), cps | 120 | 100 |
| Gel Time, min. | 22 | approx. 25 |
| Penetrates cracks less than 0.002 inch in | Yes | Yes |
| width | | |

*For these tests, a 3 gallon sample of the formulation of Example 1 was compared with only a ½ gallon sample of the Sikadur 55 SLV to avoid an uncontrollable exotherm and excessive fuming.

What is claimed is:

1. An epoxy sealer/healer formulation for sealing and strengthening cracked concrete comprising at least one epoxy resin and at least one amine curing agent, said formulation providing a modulus and/or compressive strength at least that of uncracked concrete and effective for penetrating a concrete crack at a rate of at least 10 mm/min for a crack 0.5 mm wide when applied by gravity feed, wherein fuming of said formulation upon mixture of the epoxy resin and amine curing agent will not exceed about 100 Ds, and wherein the exotherm for the mixed formulation will not exceed about 480° F.

2. An epoxy sealer/healer formulation according to claim 1, wherein said formulation comprises at least one monofunctional epoxide diluent and at least one difunctional epoxide diluent, and wherein fuming of said formulation upon mixture of the epoxy resin and amine curing agent will not exceed about 75 Ds, and wherein the exotherm for the mixed formulation will not exceed about 455° F.

3. An epoxy sealer/healer according to claim 2, wherein the formulation is free of a dialkylene triamine-alkylene oxide adduct.

4. An epoxy sealer/healer according to claim 2, comprising a bisphenol A-epichlorohydrin resin and bisphenol F-epichlorohydrin resin.

5. An epoxy sealer/healer according to claim 2, comprising isophorone diamine and aminoethyl piperazine.

6. An epoxy sealer/healer according to claim 1 which has a tack-free time of about 6 hours or less at 73° F.

7. An epoxy sealer/healer according to claim 1 which has a mixed viscosity of about 130 cps or less at 73° F.

8. An epoxy sealer/healer according to claim 1 which has a working life of about 20 minutes or longer for 100 gms at 73° F.

9. An epoxy sealer/healer formulation for sealing and strengthening cracked concrete comprising Part A and Part B, wherein Part A comprises from about 30 to about 50% by weight of bisphenol A-epichlorohydrin resin, from about 15 to about 25% by weight bisphenol F-epichlorohydrin resin, and from about 25 to about 43% by weight of reactive diluents provided that Part A contains from about 10 to no more than about 18% by weight difunctional reactive diluents and from about 15 to no more than about 25% by weight monofunctional reactive diluents, wherein Part B comprises from about 50 to about 70% by weight of one or more amine curing agents provided that Part B contains about 8 to about 12 % by weight of an amine curing agent which acts as an accelerant, about 15 to about 25% by weight non-amine accelerant(s), and about 15 to about 25% by weight diluent, and wherein the exotherm for the mixed formulation of Part A and Part B will not exceed about 480° F.

10. An epoxy sealer/healer formulation for sealing and strengthening cracked concrete according to claim 9, said formulation providing a modulus and/or compressive strength at least that of uncracked concrete and effective for penetrating a concrete crack at a rate of at least 10 mm/min for a crack 0.5 mm wide when applied by gravity feed.

11. An epoxy sealer/healer formulation for sealing and strengthening cracked concrete according to claim 10, wherein Part A comprises from about 35 to about 45% by weight of bisphenol A-epichlorohydrin resin, from about 17 to about 23% by weight bisphenol F-epichlorohydrin resin, from about 15 to about 16% by weight difunctional reactive diluents and from about 20 to about 25% by weight monofunctional reactive diluents, and wherein Part B comprises from about 60 to about 65% by weight of one or more amine curing agents provided that Part B contains about 8 to about 12% by weight of a tertiary amine curing agent with hydroxyl functionality, about 18 to about 22% by weight non-amine accelerant(s), and about 15 to about 20% by weight hydroxylated aromatic diluent.

12. An epoxy sealer/healer formulation for sealing and strengthening cracked concrete according to claim 9, wherein Part B is not formulated with phenol or nonyl phenol.

13. An epoxy sealer/healer formulation for sealing and strengthening cracked concrete according to claim 9, wherein Part B is substantially free of a dialkylene triamine-alkylene oxide adduct.

14. An epoxy sealer/healer formulation for sealing and strengthening cracked concrete comprising Part A and Part B, wherein Part A comprises an epoxy resin, neopentyl glycol diglycidylether, neodecanoic glycidyl ether and 2-ethylhexylglycidylether, and Part B comprises an amine curing agent.

15. An epoxy sealer/healer formulation for sealing and strengthening cracked concrete according to claim 14, wherein Part B comprises isophorone diamine, aminoethyl piperazine, 2,4,6,-tri(dimethylaminomethyl)phenol, a styrenated phenol, salicylic acid and benzyl alcohol.

16. An epoxy sealer/healer formulation for sealing and strengthening cracked concrete comprising Part A and Part B, wherein Part A comprises about 40% by weight bisphenol A-epichlorohydrin resin, about 21% by weight bisphenol F-epichlorohydrin resin, about 15% by weight neopentyl glycol diglycidylether, about 5% by weight neodecanoic glycidyl ether and about 19% by weight 2-ethylhexylglycidylether, and wherein Part B comprises an amine curing agent.

17. An epoxy sealer/healer formulation for sealing and strengthening cracked concrete according to claim 16, wherein Part B comprises about 42% by weight isophorone diamine, about 11% by weight aminoethyl piperazine, about 10 weight % 2,4,6,-tri(dimethylaminomethyl)phenol, about 17% by weight styrenated phenol, about 3% by weight salicylic acid and about 17% by weight benzyl alcohol.
